(19) United States
(12) Patent Application Publication
(10) Pub. No.: US 2008/0168880 A1
(43) Pub. Date: Jul. 17, 2008

(54) Bagel dough dividing apparatus

(76) Inventor: Alex Kuperman, Woodbridge (CA)

Correspondence Address: McCarthy Tetrault LLP, Box 48, Suite #4700 Toronto Dominion Bank Tower, TORONTO, ON, M5K 1E6, omitted

(21) Appl. No.: 11/652,541

(22) Filed: Jan. 12, 2007

(51) Int. Cl. B26D 3/00

(52) U.S. Cl. 83/870

(57) ABSTRACT

A bagel dough dividing apparatus having a housing and a manually installable knife assembly for cutting bagel dough introduced into said housing is disclosed. The knife assembly includes: a rotatable shaft; at least one blade mounted to said shaft; and an engagement feature at a shaft first end for releasably engaging a drive assembly mounted to said housing for rotating said removable knife assembly about an axis. The knife assembly may be rotatably mounted at a second end to the housing. The engagement feature may have a configuration complimentary to a corresponding configuration on the drive mechanism to engage the drive mechanism when manually placed adjacent thereto. The engagement feature may include a protrusion axially extending from the shaft, and the protrusion may have a generally semi-cylindrical shape complimentary to a shape of said drive mechanism.

### FIELD OF THE INVENTION

The invention relates to the field of bakery equipment. More specifically, the present invention relates to a bagel dough dividing apparatus.

### BACKGROUND OF THE INVENTION

Dough used for making bagels tends to be much stiffer than dough used for other bakery products. This stiffness generally requires that the apparatus used for the processing of bagel dough is durable. In particular, the divider and related components of the bagel processing machinery should be durable enough to withstand the forces required to cut and manage the stiffer bagel dough. In order to accommodate the stiffer dough, bagel dough dividing apparatus tend to include components that are mounted to one another in such a way that it is relatively difficult to remove them, for example, for cleaning or maintenance. Such components typically require the use of tools, such as hand or power tools, to remove bolts and other elements used to secure the components of the bagel dough dividing apparatus. A benefit of securely attaching the machinery components is that such machines are able to operate, potentially around the clock, without the need for significant maintenance. If maintenance is required, then the processing machinery may need to be shut down for a significant period of time for repairs. Such down time may significantly reduce the productivity of the machinery. Similarly, it may be difficult and time consuming to reconfigure such machinery to produce varied bagel products.

Apparatus for cutting bakery dough and other mixtures are disclosed, for example, in U.S. Pat. No. 4,193,272 to Bernard; U.S. Pat. No. 2,356,872 to Monaco; U.S. Pat. No. 3,217,575 to Anetsberger; and U.S. Pat. No. 4,655,110 to Cowlin et al. There is a need for suitable bagel dough processing apparatus.

### SUMMARY OF THE INVENTION

In accordance with a broad aspect of the present invention there is provided a bagel dough dividing apparatus including a housing; a manually installable knife assembly for cutting bagel dough introduced into the housing. The knife assembly may include: a rotatable shaft; at least one blade mounted to the shaft; and an engagement feature at a shaft first end for releasably engaging a drive assembly mounted to the housing for rotating the removable knife assembly about an axis. The knife assembly may be rotatably mounted at a second end to the housing.

According to an embodiment of the invention, the engagement feature has a configuration complimentary to a corresponding configuration on the drive mechanism to engage the drive mechanism when manually placed adjacent thereto.

According to a further embodiment of the invention, the engagement feature includes a protrusion axially extending from the shaft, the protrusion having has a generally semi-cylindrical shape complimentary to a shape of the drive mechanism.

According to an embodiment of the invention, there is provided a support for at least one of the first end and the second end, the support defining an opening therein to receive the end, and the opening having an orientation to permit the end to rest within the support without the need for additional attachment when the knife assembly is idle.

In an aspect of the invention, the support is generally cylindrical and oriented coaxially with the shaft.

In a further aspect of the invention, the opening includes a portion that is generally U-shaped.

In a yet further aspect of the invention, there is provided a second support for the other of the first and second ends, the second support being mounted to the housing; and openings of the supports being oriented to permit passage of the first and second ends coincidently.

In an embodiment there is also provided a retainer for inhibiting the movement of one of the first and second ends when the end is located within the support, the retainer being manually movable between open and closed positions, the end being movable within the support opening when the retainer is in an open position, and non-axial movement of the end is inhibited when the retainer is in a closed position.

In an aspect, the retainer is rotatable about the support and the axis when moved between the open and closed positions, and the retainer includes a grip thereon for manually rotating the retainer between the open and closed positions.

Furthermore a second retainer may be included for the other of the first and second ends.

In a further aspect, the retainer defines a retainer opening generally congruent to the support opening, the retainer opening being generally aligned with the support opening to permit passage of the end when the retainer is in an open position.

According to an embodiment, there may be provided a removable conveyor mounted to the housing with a manually installable and removable fastener.

According to an aspect, an end of the conveyor may be mounted adjacent the knife assembly to receive bagel dough portions from the knife assembly, and the fastener includes hand knobs.

According to a further aspect, the conveyor may include a drive shaft having an end, the drive shaft end being configured to engage a corresponding conveyor drive mechanism when the drive shaft end is manually placed adjacent thereto.

According to a yet further aspect, the drive shaft end includes at least one engagement feature axially extending from the drive shaft for coming into contact with a rotatable element of the conveyor drive mechanism to permit the conveyor drive mechanism to rotate the drive shaft.

Furthermore, the engagement feature may be generally parallel to an axis of rotation of the drive shaft, and the engagement feature is elongate.

In a further aspect, the conveyor includes at least one discharge lane, wherein each the at least one discharge lane is precisely aligned with one of the at least one blade permitting delivery of bagel dough portions onto the discharge lane.

According to another broad aspect of the invention, there is provided a method for configuring a bagel dough processing apparatus having a housing with a first knife assembly mountable therein. The apparatus may include supports for ends of the knife assembly and manually movable retainers at each end of the knife assembly. The apparatus may have a drive assembly for releasably engaging a first end of the knife assembly. The method includes the steps of:

manually moving the retainers from a closed position to an open position;

manually removing the first knife assembly from the supports and out of engagement with the drive assembly;

manually replacing the first knife assembly with a replacement knife being one of: a second knife assembly that is similar to the first knife assembly, a second knife assembly configured to produce bagel dough portions having different dimensions than produced by the first knife assembly, a repaired first knife assembly, and a modified first knife assembly;

manually placing ends of the replacement knife into the supports;

manually engaging the first end with the drive assembly; and

manually moving the retainers to a closed position to retain the ends therein.

In an embodiment, the method may include the first knife assembly being replaced with a second knife assembly configured to produce bagel dough portions having different dimensions than produced by the first knife assembly.

In a yet further embodiment of the method, the processing apparatus may include a first conveyor for cooperating with the first knife assembly to transport bagel dough portions delivered by the first knife assembly, and the conveyor may be mounted to the housing by at least one manually removable and installable fastener. The method may further include the steps of:

manually removing the at least one fastener;

manually replacing the first conveyor with a replacement conveyor being one of: a second conveyor that is similar to the first conveyor, a second conveyor configured to transport bagel dough portions having different dimensions than transported by the first conveyor, a repaired first conveyor, and a modified first conveyor; and

manually re-installing the at least one faster to secure the replacement conveyor.

According to an aspect of the method, the first conveyor may be replaced with a second conveyor configured to transport bagel dough portions having different dimensions than transported by the first conveyor.

According to a further aspect of the method, the step of removing the first conveyor may be performed after the step of removing the first knife assembly.

According to another broad aspect of the invention, there is provided use of a first and a second manually releasable retainer for securing to a housing of a bagel processing apparatus, respective first and second ends of a knife assembly for cutting bagel dough.

Other and further advantages and features of the invention will be apparent to those skilled in the art from the following detailed description of embodiments thereof, taken in conjunction with the accompanying drawings.

### BRIEF DESCRIPTION OF THE FIGURES

The present invention will be further understood from the following detailed description of embodiments of the invention, with reference to the drawings in which:

FIG. 1 illustrates in a side view, a bagel dough processing apparatus in accordance with an embodiment of the present invention;

FIG. 2 is a top view of the bagel dough processing apparatus of FIG. 1 additionally illustrating the section at 2-2, with a related knife assembly in exploded view;

FIG. 3 is an alternative top view of the apparatus of FIG. 1 having differently configured discharge lanes, with a related knife assembly in exploded view;

FIG. 4 is a perspective view of a divider having a four lane discharge conveyor;

FIG. 5 is a front perspective view of the divider of FIG. 4 with a panel thereof removed;

FIG. 6 is an enlarged view of FIG. 5;

FIG. 7 is an end view of FIG. 5 with the conveyor assembly also shown from the back

FIG. 8 is a partial transparent view of the divider of FIG. 4;

FIG. 9 illustrates an isolated view of an embodiment similar to the knife assembly shown in FIG. 8;

FIG. 10 is an isolated view of the knife assembly of FIG. 8;

FIG. 11 is a perspective view of the knife assembly of FIG. 10 including partial details of mounting and drive apparatus in partial quarter sectional view;

FIG. 12 is a perspective view of the knife assembly of FIG. 9 including partial details of mounting and drive apparatus in partial quarter sectional view;

FIG. 13 is an exploded view of components illustrated in FIGS. 11 and 12;

FIG. 14 is an enlarged view of the knife assembly of FIG. 9, mounted adjacent to a conveyor as illustrated in FIG. 3, wherein the knife mounting assembly is in a closed position;

FIG. 15 is a view similar to that of FIG. 14 wherein the knife mounting assembly is in a generally open position;

FIG. 16 is an enlarged perspective view similar to the assembly shown in FIG. 15 having the knife assembly removed;

FIG. 17 is an enlarged view of the conveyor drive assembly shown in FIG. 14.

### DETAILED DESCRIPTION OF THE INVENTION

Similar references are used in different figures to denote similar components.

FIG. 1 illustrates a bagel dough dividing apparatus 10 and related components in accordance with an embodiment of the present invention. Apparatus 10 may include a divider 12 and removable conveyor components such as discharge conveyor 14 and intermediate conveyor 16. Discharge conveyor 14 may conveniently be provided with a feature to permit its easy movement such as wheels 18. Wheels 18 may facilitate the efficient removal of discharge conveyor 14 for a replacement conveyor or a conveyor having a different configuration.

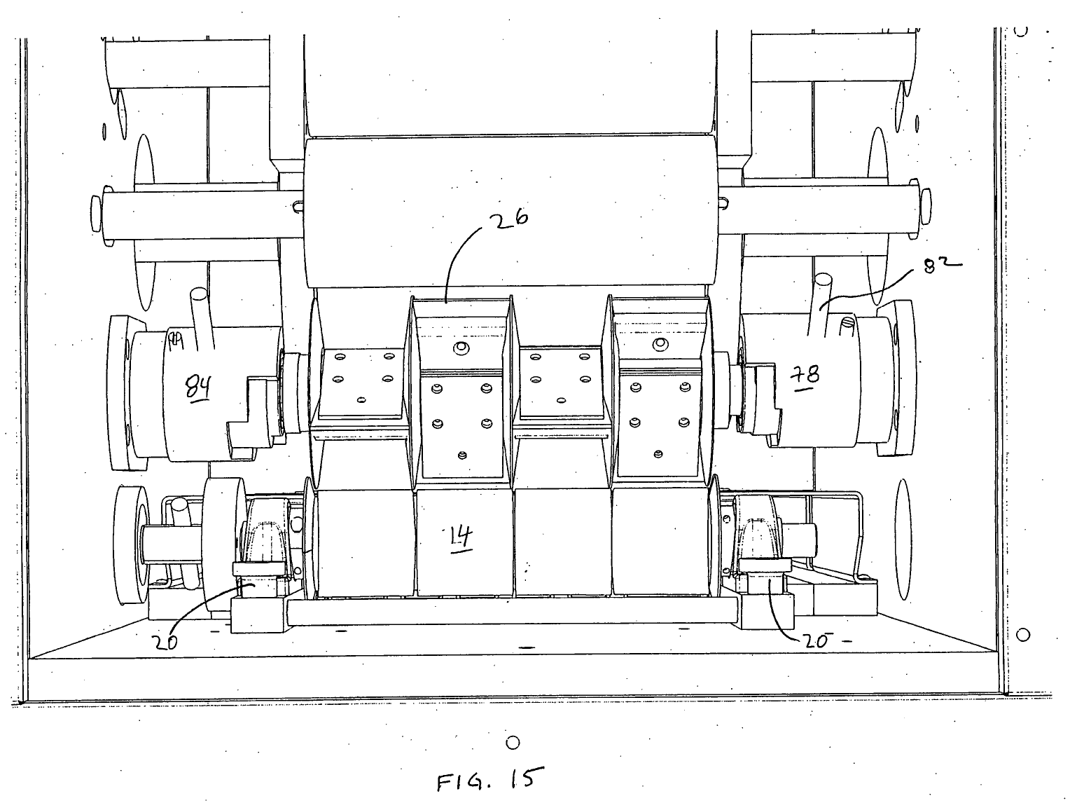

Discharge conveyor 14 may be attached or mounted to divider 12 by a manually operable mounting feature, such as hand knobs 20 (discussed in greater detail below in the context of FIG. 14, and following figures). Discharge conveyor 14 conveniently overlaps intermediate conveyor 16, again, to provide ready removal and/or replacement of the conveyor 14, intermediate conveyor 16, or some other component of the conveyor system.

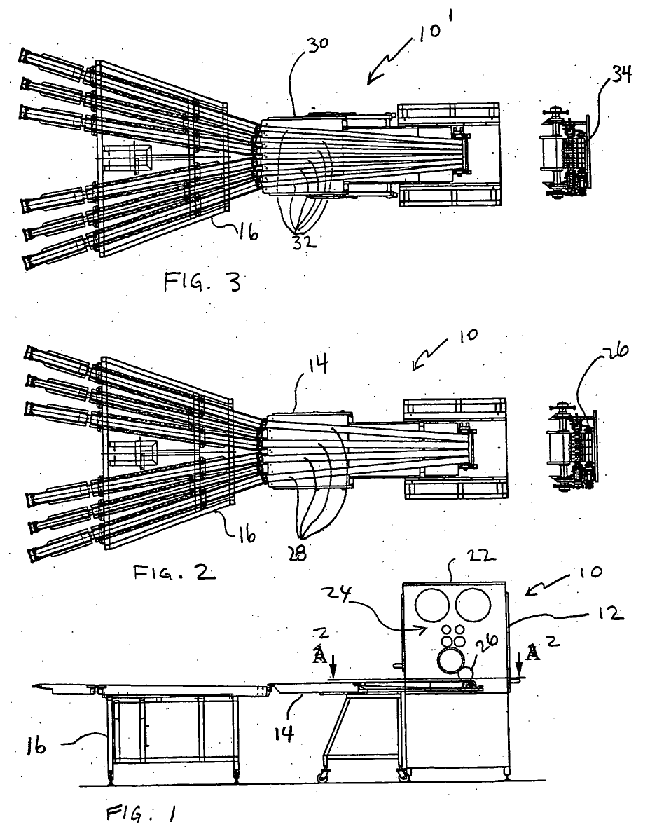

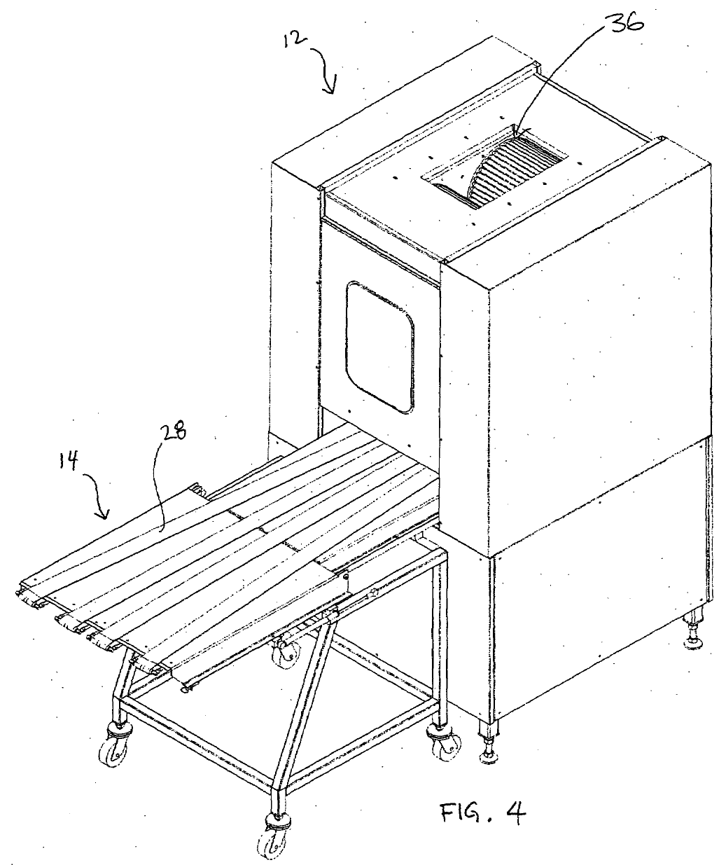

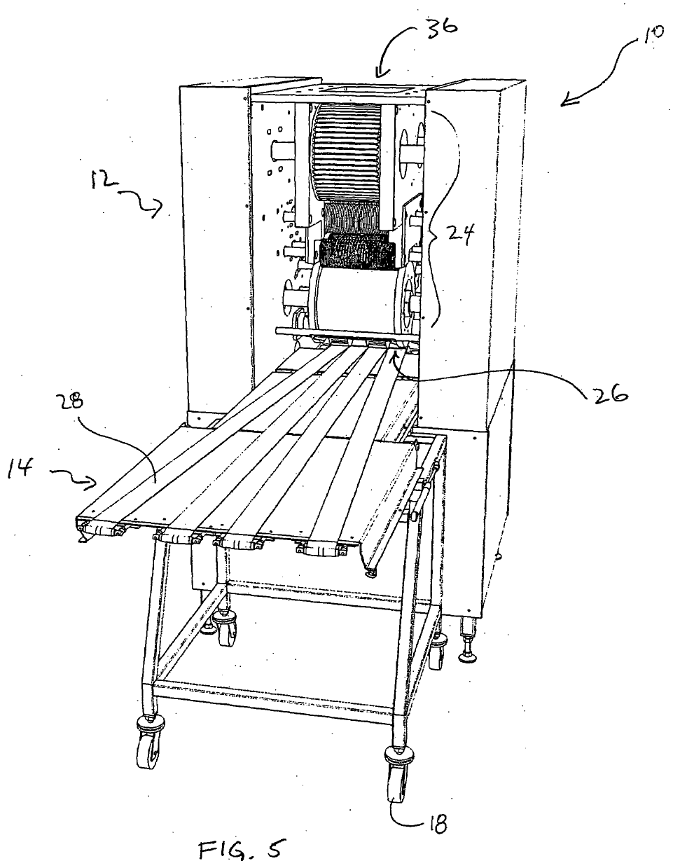

FIGS. 2 and 3 illustrate variants of discharge conveyor 14. Discharge conveyor 14 is illustrated in FIG. 2 having four conveyor bands. Bagel dough placed in a hopper (not shown) via a top end 22 of divider 12 (see FIG. 1) is processed through a roller assembly 24 (illustrated in phantom in FIG. 1). Roller assembly 24 directs bagel dough to a knife assembly 26 for separating the dough into portions for further processing into a single bagel product.

The various components of divider 12 are preferably made to accommodate the stiffer dough required for making bagels and any other products that require a stiffer dough. Ideally, divider 12 and the related apparatus are made to run continuously at least 40 hours a week and up to continuous operation 24 hours a day, 7 days a week. The processing apparatus 10 should be built of sufficient quality and durability for minimum down time, and preferably with nearly zero percent down time, including when used for high speed bagel production.

It has been determined that the driving portion (such as at or about end 42 shown in FIG. 9) of the knife is subjected to increased forces when mounted and clamped. It has also been determined that, over time, this section of the knife is subjected to excessive wear. The knife design may include an interchangeable driving tongue which along with the drive shaft may be hardened to insure durability.

In FIG. 2, discharge conveyor 14 is provided with four discharge lanes 28. Lanes 28 correspond to outlets of knife assembly 26 (as seen, for example, in FIG. 7). This arrangement conveniently provides a means for transporting bagel dough that has been divided into bagel-sized chunks for forming into bagels and for further processing.

FIG. 3 illustrates an alternative embodiment, labeled 10′, in which a discharge conveyor 30 includes six discharge lanes 32, and a corresponding knife assembly 34 having an arrangement of knives corresponding to discharge lanes 32 (see, for example, FIG. 14). Components of this alternative embodiment may be interchanged with the embodiment illustrated in FIG. 2 to permit different sized bagel dough portions to be cut and conveyed for further processing. The particular number of discharge lanes and the arrangement of knives may be varied to permit larger or smaller pieces of bagel dough to be accommodated for processing. The shape of the bagel dough may also be changed by varying the configuration of the knife assemblies (for example, 26 or 34). Such variation may be used to produce different bagel products such as a “regular” or “standard” sized bagel (using the apparatus of FIG. 2), or a smaller “mini-bagel” using the apparatus of FIG. 3. It should be emphasized that other configurations for the discharge lanes and knife assemblies may be employed to produce different bagel products.

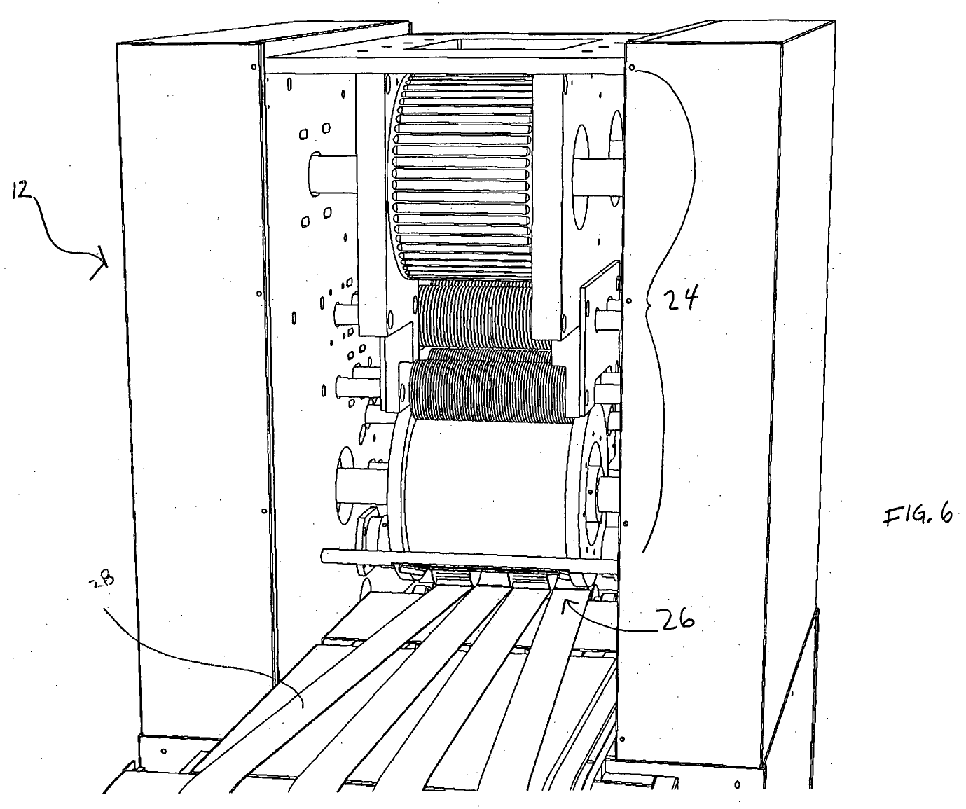

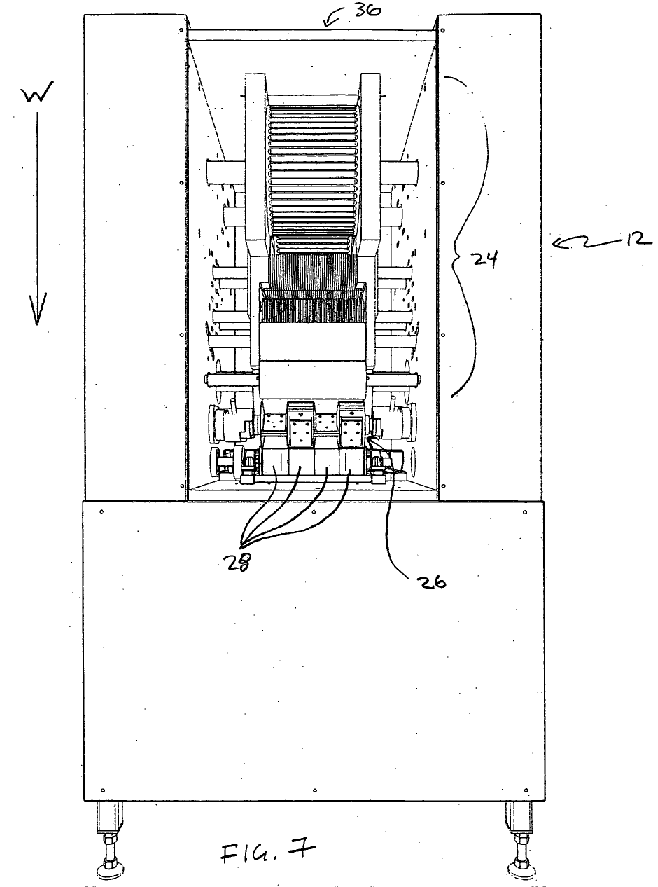

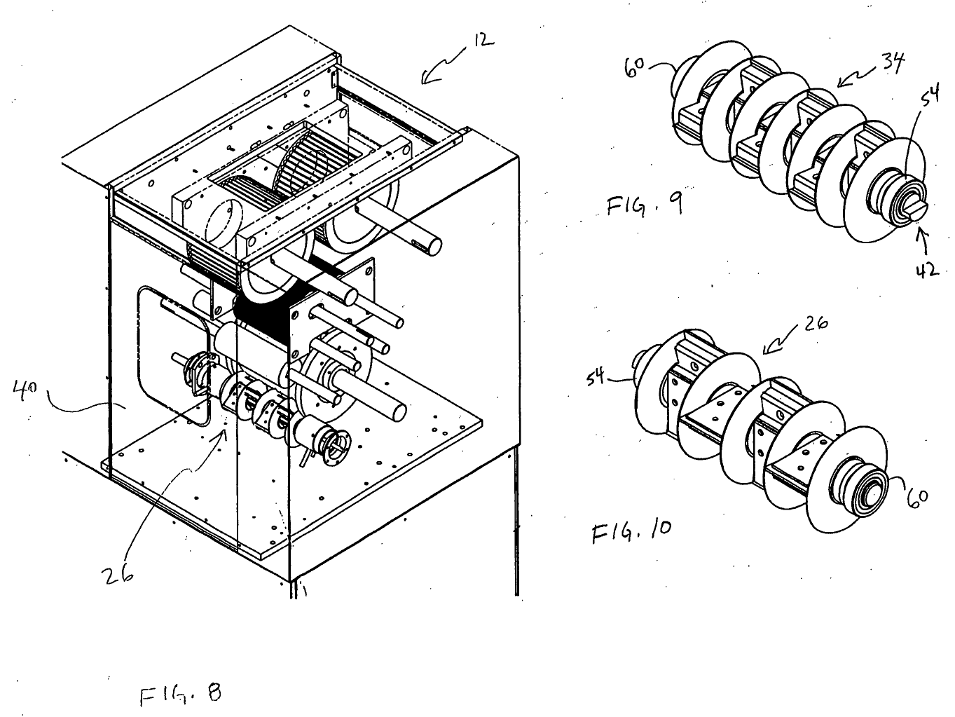

FIG. 4 illustrates a perspective isolated view of divider 12 and discharge conveyor 14. Bagel dough placed in hopper 36 is processed and divided onto discharge lanes 28.

Similarly, FIG. 5 illustrates discharge lane 28 in alignment with knife assembly 26, and roller assembly 24. An enlarged view is provided in FIG. 6.

FIG. 7 illustrates an end view of divider 12 from a side opposite to discharge conveyor 14. It should be noted that description of discharge conveyor 14 and related components, including knife assembly 26, applies generally and particularly, as appropriate, to other embodiments, including discharge conveyor 30 and knife assembly 34.

FIG. 7 shows the general passage of dough through divider assembly 12 in general direction W. Dough passes through rollers 24 from hopper 36 into knife assembly 26. Knife assembly 26 divides the stiff bagel dough into appropriately sized chunks onto conveyor discharge lanes 28, for delivery to further processing apparatus where the chunks may be formed into shapes such as the toroid shapes associated with traditional bagel. The forming aspect of the process is not addressed here.

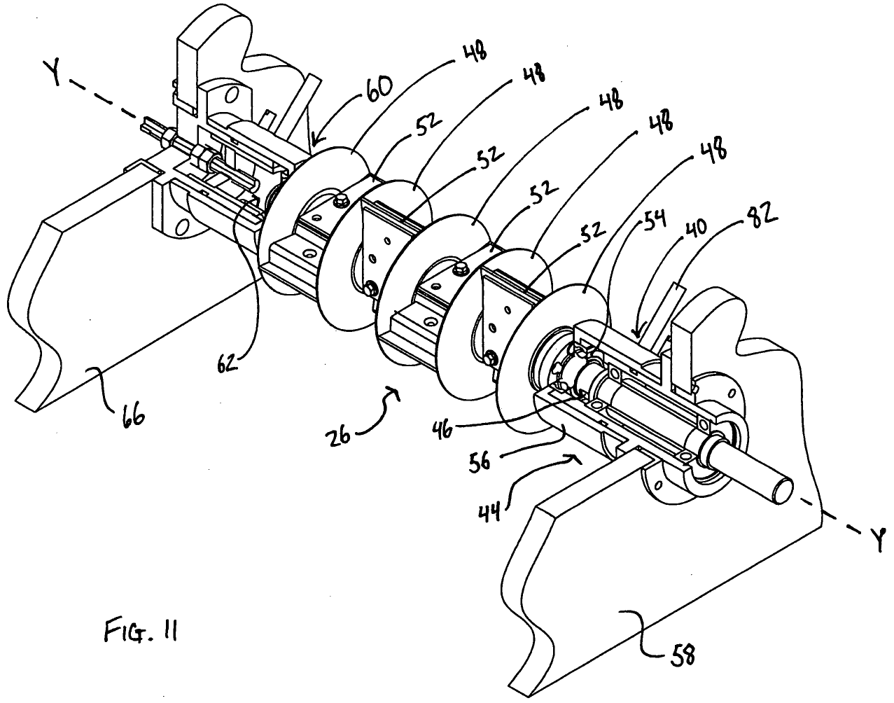

FIG. 8 illustrates a partial transparent view of divider 12, with discharge conveyor 14 and associated mounting components not illustrated. As noted, knife assembly, such as knife assembly 26, may be conveniently and easily removed and replaced with another knife assembly such as knife assembly 34. This may be done by opening or removing door 40 of divider assembly 12 to obtain access to the knife assembly. Knife assembly 26 may be manually released from divider assembly 12. It has been found that an operator can release, remove, and replace knife assembly 26 in about one minute, even if such operator has little or no experience with the apparatus 10.

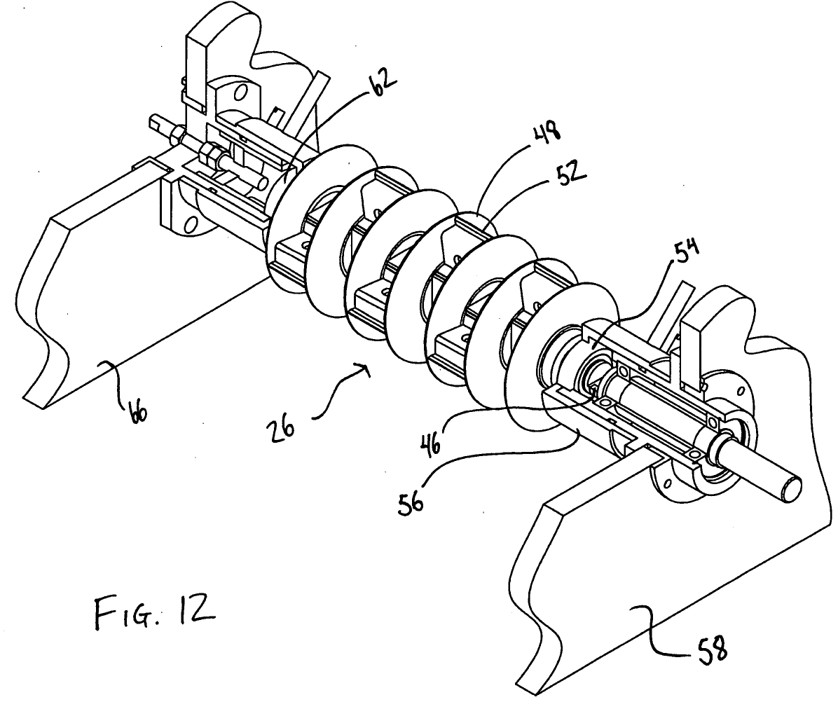

FIGS. 9 and 10 illustrate knife assemblies 34 and 26, respectively. It should be noted that the knife assemblies 34 and 26 are self-contained units that may be readily removed from divider assembly 12 and replaced with other assemblies. This may be done in order to repair a knife assembly or to permit the divider assembly 12 to produce bagel dough portions having a different configuration and/or size. For example, knife assembly 26 may be readily removed and replaced with bagel assembly 34 by simply manually releasing assembly 26, lifting it out and away from divider 12. Knife assembly 34 may then be lifted and placed within divider 12, manually secured therein, and divider 12 may then be operated to produce bagel dough portions of a smaller size.

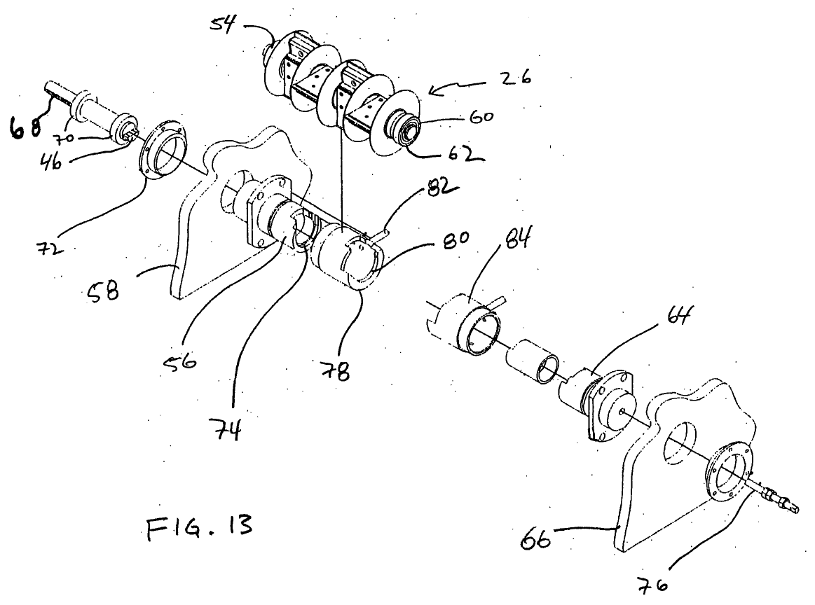

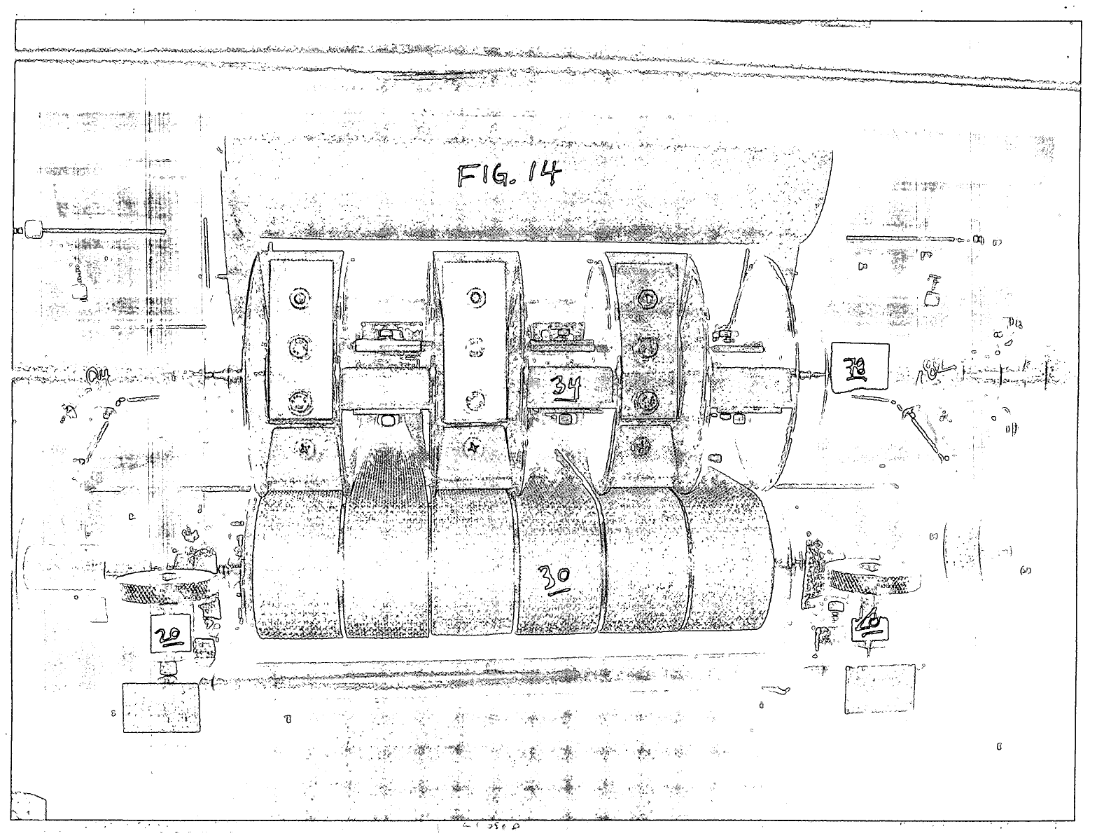

FIGS. 11, 12 and 13 illustrate in greater detail components of an embodiment of the knife assembly and the associated drive and mounting apparatus. Knife assembly 26 is a rotary knife capable of rotation about its longitudinal axis Y. Knife assembly 26 includes a drive end 42 (best seen in the context of knife assembly 34 of FIG. 9). Drive end 42 may have any configuration to conveniently engage a drive assembly, such as a drive assembly 44, which is connected to a drive motor or other apparatus for imparting a rotational force to knife assembly 26. Such components of the assembly serve to facilitate transmission of forces required to rotate components of divider 12, such as knife assembly 26, to divide the relatively stiffer dough required for bagel production.

Drive end 42 in the present embodiment includes a shape complimentary to an engagement feature 46 of drive assembly 44. For example, engagement feature 46 may be a partial cylindrical shape extending along axis Y. Engagement feature 46 may be semi-cylindrical for example. Drive end 26 may be the complimentary half to semi-cylindrical engagement feature 46, as shown in FIGS. 11 to 13. This arrangement permits knife assembly 26 to be easily placed in engagement with drive assembly 44, while at the same time providing a secure and reliable connection between drive assembly 44 and knife assembly 26. Other convenient configurations and geometries may also be used, so long as knife drive end 42 may be conveniently and quickly placed into engagement with feature 46. For example a tongue and groove type arrangement, multiple jaws (for example, three), a pin inserted into mating grooves, etc. may be employed.

When drive assembly 44 is rotated, it causes knife assembly 26 to rotate, thereby causing blades 48 of knife assembly 26 to spin. Blades 48 are preferably round and engage axially with the shaft of knife assembly 26. Blades 48 are spaced axially along axis Y in order to produce a bagel dough portion of a width corresponding to the spacing of adjacent blades 48. The spacing need not be uniform, but is preferably uniform to correspond to discharge lanes of conveyor 14.

A length of bagel dough is affected by longitudinal spacers 52, which cooperate with blades 48 to divide bagel dough into portions having dimensions affected by the perimeter defined by edges of adjacent blades 48 and an associated spacer 52. The particular dimensions and number of blades 48 and spacers 52 used may be varied to provide bagel dough portions of different sizes and shapes. In the “Y” direction, the length of the dough piece is defined by the distance between the circular blades 48. In a direction of dough travel generally normal to “Y”, the length of the cut piece is determined at least in part by the speed of the dough band processed by the divider 12. Thus as the knife turns, the dough is cut to a certain length; if the speed of the dough travel changes, the dough piece becomes shorter or longer. The thickness of the dough chunk is determined by the gap between respective sets of rollers 24.

Blade assembly 26 may include a bearing 54 that may be mounted adjacent drive end 42. Bearing 54 may rest within a housing 56 mounted to a structural feature of divider 12, such as wall 58. Bearing 54 facilitates the rotation of knife assembly 26 when driven by drive assembly 44. Knife assembly 26 may be similarly mounted at an opposite end 60 thereof. (See FIG. 10). In particular, opposite end 60 may include a bearing 62 for ready placement within a housing 64. Housing 64 may be mounted to a feature of divider such as opposite wall 66.

The foregoing assembly can be seen (perhaps best in FIG. 11) to permit knife assembly 26 to be easily lifted out of housings 56 and 64, and out of engagement with drive assembly 44. A replacement or repaired knife assembly may be easily placed within housings 56 and 64 in a very short period of time, manually and without the need for tools.

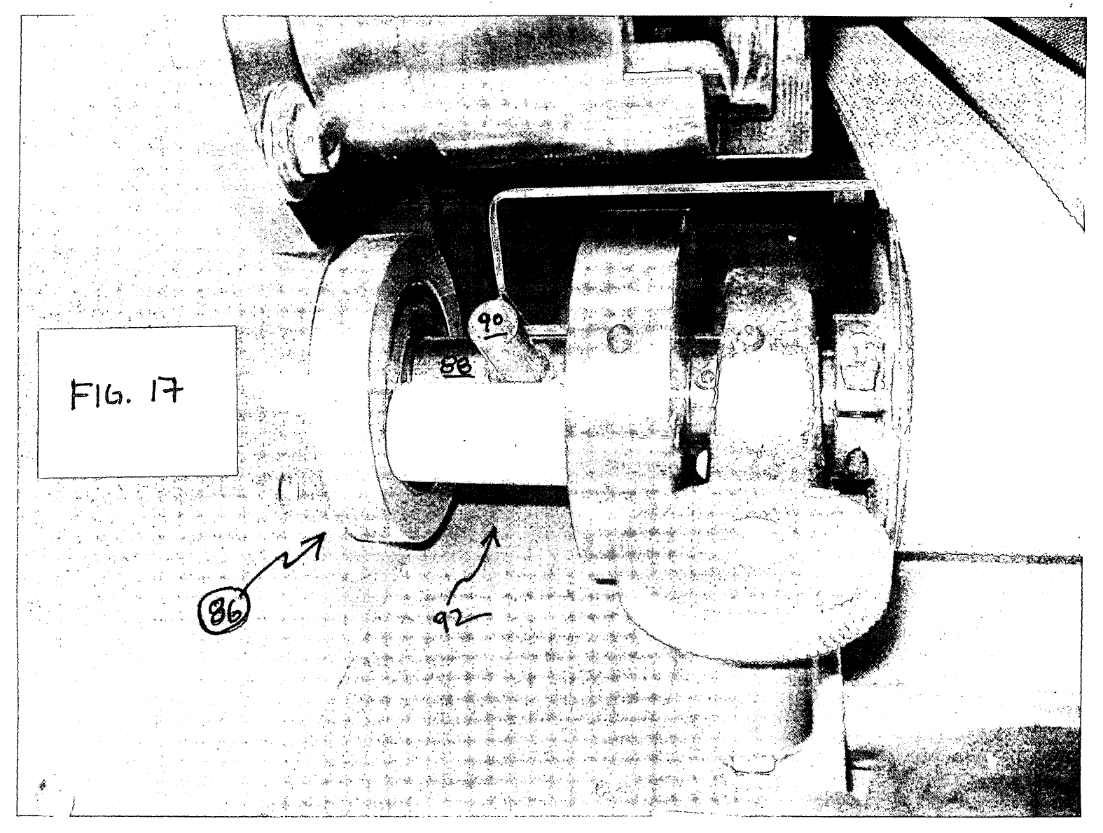

FIG. 13 illustrates components of an embodiment of knife assembly 26 and related elements. It should be emphasized that these components may be varied and modified as necessary or desired in order to provide a convenient and efficient apparatus for retaining a removable driven knife assembly for processing bagel dough. In particular, and in addition to the elements already described, the various assemblies may include the following. Drive assembly 44 may include a shaft 68 for rotating engagement feature 46. Drive assembly 44 may also include bearings 70 to facilitate rotation of the drive assembly. Drive assembly 44 may be mounted through wall 58 within an eccentric fitting 72. Eccentric fitting 72 also receives and secures housing 56. Housing 56 may be configured to include a generally U-shaped receptacle 74 for receiving drive end 26 of knife assembly 26. Receptacle 74 may be oriented upwards so that knife assembly 26 may rest therein by gravity. Alternatively, receptacle 74 may be oriented having the U-shape opening to the rear of the divider 12 (see, for example, FIG. 16), permitting removal of a knife assembly laterally to clear adjacent components such as rollers 24 and conveyor 30. Opposite end 60 of knife assembly 26 may be similarly mounted to housing 64, and housing 64 may be retained to wall 66 via a fitting 72 and retainer in the nature of a bolt 76.

Ends 42 and 60 of knife assembly 26 may be further secured and retained by a retainer such as a clamp 78. In an embodiment, clamp 78 may be rotatable about housing 56 and may include an opening 80 that generally corresponds to opening of receptacle 74, when clamp 78 is in an open position (as shown generally in FIGS. 13, 15 and 16). Clamp 78 may have a grip or other feature, such as handle 82, for manually engaging clamp 78. In the embodiment illustrated, handle 82 may be mounted to clamp 78 at an exterior thereof, and may protrude generally perpendicular to axis Y. Clamp 78 is preferably configured to be generally coaxial with and congruent to the exterior of housing 56, and to rotate generally about axis Y. Clamp 78 may be marginally eccentric with respect to housing 56 so that clamp 78 frictionally engages housing 56 when it is rotated from an open to a closed position (clamp 78 is shown in a closed position in, for example, FIGS. 8 and 14). Positioning clamp 78 in a closed position preferably causes openings 74 and 78 to come out of alignment so that end 42 of knife assembly 26, preferably along with bearing 54, becomes secured by the cooperation of housing 56 and clamp 78 End 60 of knife assembly 26 may be similarly retained by a retainer such as clamp assembly 84. Other arrangements, including threading, may also be used.

Clamp assemblies 78 and 84 facilitate the manual securing of knife assembly 26 within housings 56 and 64. For example, a knife assembly, such as knife assembly 26, may be readily removed from divider 12 by manually releasing clamps 78 and 84, using handles such as handle 82. Once the clamps are released, the knife assembly may be simply lifted out of the divider and either repaired and replaced, or replaced with a knife assembly for producing different bagel dough portions, such as knife assembly 34. As noted, other mounting and clamping arrangements may be employed so long as the assemblies described are durable enough to withstand the demands of the much stiffer bagel dough, and so long as the knife assembly may be removed, replaced and secured efficiently by hand.

FIG. 14 illustrates an enlarged view of an apparatus similar to that shown in FIG. 7, but with a knife assembly of 34 and co-operating discharge conveyor 16 which co-operate to produce bagel dough portions for delivery by the six discharge lanes 32. It will be noted that knife assembly 34 delivers bagel portions to alternating lanes 32 of discharge conveyor 30. This is merely an example, and knife assembly 34 and co-operating conveyor 30 may be configured to discharge bagel dough portions in some other pattern or manner that may be convenient.

FIG. 14 also shows clamps 78 and 84 in a generally closed position which permits knife assembly 34 to be rotated by drive assembly 44. Knife assembly 34 may be aligned with discharge conveyor 30, to position dough portions on discharge lanes thereof. As noted above, if discharge conveyor 30 or knife assembly 34 requires replacement for repair or to reconfigure or replace divider 12 to produce bagel dough portions having different characteristics, this may be done relatively easily by an operator having relatively little experience.

Either knife assembly 34 or discharge conveyor 30 may be removed first. Preferably knife assembly 34 is removed first. Drive assembly 44 must be first turned off. Clamps 78 and 84 may then be moved to the open position, either individually or at the same time. This is preferably done manually, however, the clamp assemblies may become over tightened and may require a tap by hand or a suitable object such as a rigid object to encourage movement of the clamp to an open position. Alternatively or additionally, an external hand tool may be used to provide greater leverage, for example, on clamp handle 82. In a preferred embodiment, all removal and replacement of knife assembly 34 and discharge conveyor 30 is done by hand.

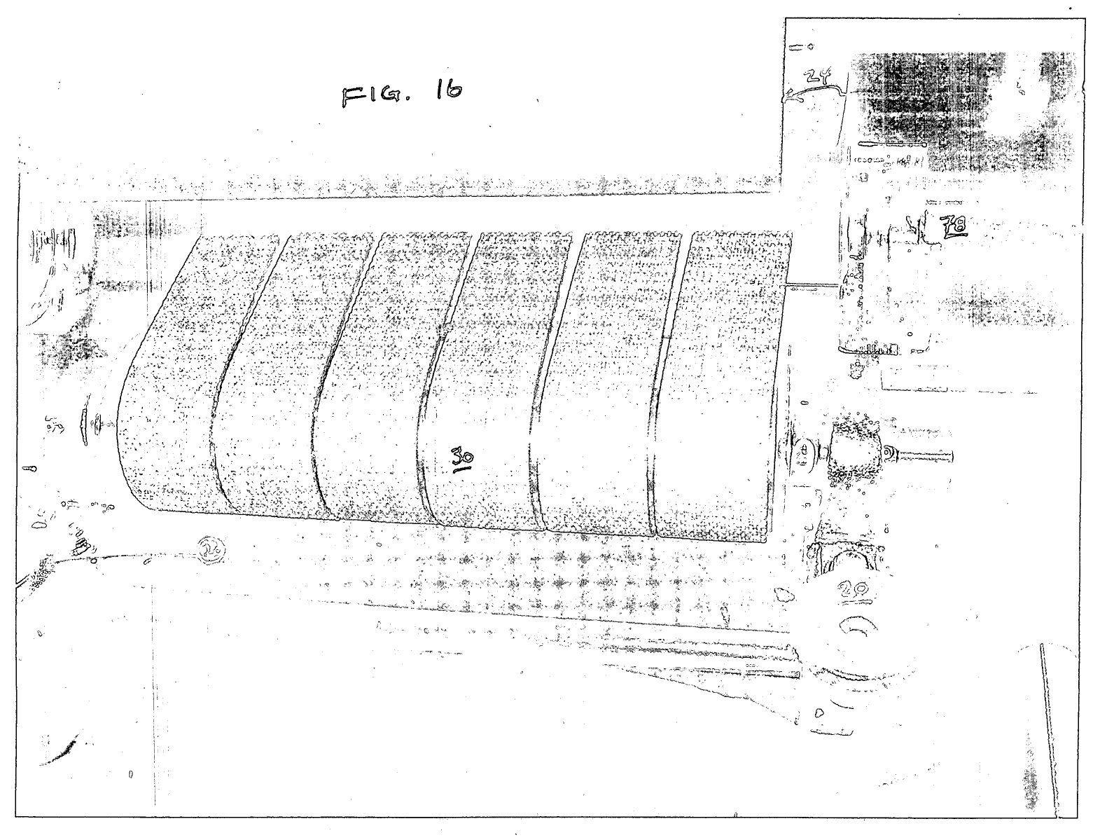

FIG. 15 illustrates clamps 84 and 78 in a nearly open position. Once clamps 78 and 84 are in a fully open position (see FIG. 16) the knife assembly may be lifted out by an operator. If the conveyor mounting members, such as hand knobs 20, have not already been loosened and/or removed, they may be removed or loosened at this stage. This permits the discharge conveyor, for example 30, to be removed from divider 12, and repaired and replaced, or replaced with a different conveyor of the same or an alternative configuration. Similarly, the knife assembly may be repaired and replaced, or replaced with a similar or differently configured assembly.

It has been found that the configuration of components described herein enables a relatively inexperienced operator to take as few as about four minutes to remove and replace both the knife assembly (such as 26) and discharge conveyor (such as 30). As noted, a benefit of this apparatus is that a knife assembly for cutting mini bagels in rows of six may be quickly replaced, along with an associated conveyor, and replaced with blades for cutting regular bagels in rows of four, with an associated conveyor having four lanes.

FIG. 17 illustrates a portion of a drive assembly for a discharge conveyor, such as discharge conveyor 30. This drive assembly, labeled 86 may include a drive shaft 88 having a drive engagement feature for engagement with an end of a conveyor drive 92. End 92 may include a feature 94 that is complementary to drive engagement feature 90.

Complimentary features 90 and 94, in a similar manner to features 42 and 46 related to the knife assembly, are configured for ready tool-less engagement that facilitates installation and removal of the discharge conveyor without the requirement of tools, while at the same time providing sufficient durability for the operational demands of the assembly 10 for processing stiff dough, such as bagel dough. As illustrated in FIG. 17, drive engagement feature 90 may be as simple as a protrusion such as a post, which may be perpendicular to drive shaft 88. The complimentary feature 94 may simply be an obstructing protrusion from conveyor drive and 92 which comes into contact with the drive engagement feature 90 when drive shaft 88 is rotated. One or more of complementary features 90 and 92 may be employed for greater leverage and/or engagement of drive shaft 88 and end of conveyor drive 92. Rotation of drive shaft 88 thereby imparts a rotational force on conveyor drive end 92 causing discharge lanes, such as discharge lanes 32, to move and to carry bagel portions cut by a knife assembly such as knife assembly 34 to a desired location.

It should be emphasized that other drive engagement features and variations of the described preferred engagement features may be employed so long as such features facilitate the installation removal of a discharge conveyor, such as discharge conveyor 30.

While the foregoing embodiments of the invention have been described in some detail for purposes of clarity and understanding, it will be appreciated by one skilled in the art, that numerous modifications, variations, and adaptations may be made to the particular embodiments of the invention described above without departing from the scope of the invention, which is defined in the following claims.

What is claimed is:

1. A bagel dough dividing apparatus comprising:
a housing;
a manually installable knife assembly for cutting bagel dough introduced into said housing, said knife assembly including:
a rotatable shaft;
at least one blade mounted to said shaft;
an engagement feature at a shaft first end for releasably engaging a drive assembly mounted to said housing for rotating said removable knife assembly about an axis; and
wherein said knife assembly is rotatably mounted at a second end to said housing.

2. The apparatus of claim 1, wherein said engagement feature has a configuration complimentary to a corresponding configuration on said drive mechanism to engage said drive mechanism when manually placed adjacent thereto.

3. The apparatus of claim 2, wherein said engagement feature includes a protrusion axially extending from said shaft, said protrusion having has a generally semi-cylindrical shape complimentary to a shape of said drive mechanism.

4. The apparatus of claim 2, further comprising a support for at least one of said first end and said second end, said support defining an opening therein to receive said end, and said opening having an orientation to permit said end to rest within said support without the need for additional attachment when said knife assembly is idle.

5. The apparatus of claim 4, wherein said support is generally cylindrical and oriented coaxially with said shaft.

6. The apparatus of claim 5, wherein said opening includes a portion that is generally U-shaped.

7. The apparatus of claim 6, further comprising a second support for the other of said first and second ends, said second support being mounted to said housing; and openings of said supports being oriented to permit passage of said first and second ends coincidently.

8. The apparatus of claim 4, further comprising a retainer for inhibiting the movement of one of said first and second ends when said end is located within said support, said retainer being manually movable between open and closed positions, said end being movable within said support opening when said retainer is in an open position, and non-axial movement of said end is inhibited when said retainer is in a closed position.

9. The apparatus of claim 8, wherein said retainer is rotatable about said support and said axis when moved between said open and closed positions, and said retainer includes a grip thereon for manually rotating said retainer between said open and closed positions.

10. The apparatus of claim 9 further comprising a second retainer for the other of said first and second ends.

11. The apparatus of claim 8, wherein said retainer defines a retainer opening generally congruent to said support opening, said retainer opening being generally aligned with said support opening to permit passage of said end when said retainer is in an open position.

12. The apparatus of claim 1, further comprising a removable conveyor mounted to said housing with a manually installable and removable fastener.

13. The apparatus of claim 12, wherein an end of said conveyor is mounted adjacent said knife assembly to receive bagel dough portions from said knife assembly, and said fastener includes hand knobs.

14. The apparatus of claim 12, wherein said conveyor includes a drive shaft having an end, said drive shaft end being configured to engage a corresponding conveyor drive mechanism when said drive shaft end is manually placed adjacent thereto.

15. The apparatus of claim 14, wherein said drive shaft end includes at least one engagement feature axially extending from said drive shaft for coming into contact with a rotatable element of said conveyor drive mechanism to permit said conveyor drive mechanism to rotate said drive shaft.

16. The apparatus of claim 15, wherein said engagement feature is generally parallel to an axis of rotation of said drive shaft, and said engagement feature is elongate.

17. The apparatus of claim 12, wherein said conveyor includes at least one discharge lane, wherein each said at least one discharge lane is precisely aligned with one of said at least one blade permitting delivery of bagel dough portions onto said discharge lane.

18. A method for configuring a bagel dough processing apparatus having a housing with a first knife assembly mountable therein, said apparatus including supports for ends of said knife assembly and manually movable retainers at each end of said knife assembly, said apparatus having a drive assembly for releasably engaging a first end of said knife assembly, said method comprising the steps of:
manually moving said retainers from a closed position to an open position;
manually removing said first knife assembly from said supports and out of engagement with said drive assembly;
manually replacing said first knife assembly with a replacement knife being one of: a second knife assembly that is similar to said first knife assembly, a second knife assembly configured to produce bagel dough portions having different dimensions than produced by said first knife assembly, a repaired first knife assembly, and a modified first knife assembly;
manually placing ends of said replacement knife into said supports;
manually engaging said first end with said drive assembly; and
manually moving said retainers to a closed position to retain said ends therein.

19. The method of claim 18, wherein said first knife assembly is replaced with a second knife assembly configured to produce bagel dough portions having different dimensions than produced by said first knife assembly.

20. The method of claim 19, wherein said processing apparatus includes a first conveyor for cooperating with said first knife assembly to transport bagel dough portions delivered by said first knife assembly, said conveyor being mounted to said housing by at least one manually removable and installable fastener, said method further comprising the steps of:
manually removing said at least one fastener;
manually replacing said first conveyor with a replacement conveyor being one of: a second conveyor that is similar to said first conveyor, a second conveyor configured to transport bagel dough portions having different dimensions than transported by said first conveyor, a repaired first conveyor, and a modified first conveyor; and
manually re-installing said at least one faster to secure said replacement conveyor.

21. The method of claim 20, wherein said first conveyor is replaced with a second conveyor configured to transport bagel dough portions having different dimensions than transported by said first conveyor.

22. The method of claim 21, wherein the step of removing said first conveyor is performed after the step of removing said first knife assembly.

23. Use of a first and a second manually releasable retainer for securing to a housing of a bagel processing apparatus, respective first and second ends of a knife assembly for cutting bagel dough.
